(19) United States
(12) Patent Application Publication
(10) Pub. No.: US 2013/0178211 A1
(43) Pub. Date: Jul. 11, 2013

(54) METHOD OF MDT CONTINUOUS MEASUREMENT AND REPORTING UNDER MULTIPLE PLMNS

(71) Applicant: SAMSUNG ELECTRONICS CO. LTD., Suwon-si (KR)

(72) Inventors: Hong WANG, Beijing (CN); Lixiang XU, Beijing (CN)

(73) Assignee: SAMSUNG ELECTRONICS CO. LTD., Suwon-si (KR)

(21) Appl. No.: 13/735,425

(22) Filed: Jan. 7, 2013

(30) Foreign Application Priority Data
Jan. 6, 2012 (CN) 2012-10003463.4

(51) Int. Cl. H04W 24/02

(52) U.S. Cl. CPC H04W 24/02
USPC 455/436; 455/422.1

(57) ABSTRACT

A method of Minimization of Drive Tests (MDT) continuous measurement under multiple Public Land Mobile Networks (PLMNs) is provided. The method includes sending, by an eNB, MDT-related information to a target eNB, or, requesting, by the target eNB, for user consent information from an MME, and transmitting the user consent information among multiple PLMNs without being lost during transmission. In addition, a method for achieving MDT reporting is provided. The method includes reporting, by the UE, a new indication, or, reporting, by the UE, a PLMN identifier configuring the MDT to the eNB, and enabling the eNB to correctly determine whether the UE is requested to report the measurement record to the eNB.

### PRIORITY

This application claims the benefit under 35 U.S.C. §119(a) of a Chinese patent application filed in the State Intellectual Property Office of the People's Republic of China on Jan. 6, 2012 and assigned Serial No. 201210003463.4, the entire disclosure of which is hereby incorporated by reference.

### BACKGROUND OF THE INVENTION

1. Field of the Invention

The present invention relates to radio communication technologies. More particularly, the present invention relates to a method of Minimization of Drive Tests (MDT) continuous measurement and reporting under multiple Public Land Mobile Networks (PLMNs).

2. Description of the Related Art

FIG. 1 is a diagram illustrating a System Architecture Evolution (SAE) according to the related art.

Referring to FIG. 1, a User Equipment (UE) 101 is a terminal device used for receiving data. An Evolution-Universal Terrestrial Radio Access Network (E-UTRAN) 102 is a radio access network, which includes macro base stations (i.e., an evolved Node B/Node B, eNB) used to provide radio network access interfaces for the UE. A Mobile Management Entity (MME) 103 is responsible for managing mobile context, session context, security information, and the like, of the UE. A Service GateWay (SGW) 104 mainly provides functions of a user plane. The MME 103 and SGW 104 may be in the same physical entity. A Packet data network GateWay (PGW) 105 is responsible for functions (i.e., billing and lawful interception) and may also be in the same physical entity with the SGW 104. A Policy and Charging Rules Function entity (PCRF) 106 provides Quality of Service (QoS) policy and billing guidelines. A Service General Packet Radio Service (GPRS) Supporting Node (SGSN) 108 is a network node device used to provide routing for data transmission in a Universal Mobile Telecommunication System (UMTS). A Home Subscriber Server (HSS) 109 is a home attribution subsystem of the UE and is responsible for protecting user information including a current position of the UE, an address of the service node, user security information, packet data context of the UE, and the like.

In an MDT, some measurement information is transmitted in a control plane to reduce a burden of manual testing. MDT measurement should support both real-time measurement and non-real-time measurement. Configuration information of the measurement is configured in an access network control system (i.e., an E-UTRAN, a UTRAN, and the like) by a network management system, and is sent to the UE through a Radio Resource Control (RRC) message of access network control system. An MDT measurement result of the UE is sent to the E-UTRAN/UTRAN, wherein a measurement report may include position information and time information. The E-UTRAN/UTRAN sends the measurement result to MDT entities in a core network.

According to schemes of initiating MDT, MDT may be divided into a management-based MDT and a signaling-based MDT. The management-based MDT indicates that the E-UTRAN/UTRAN receives an MDT activation message from a management entity, and the signaling-based MDT indicates that the E-UTRAN/UTRAN receives the MDT activation message from an MME.

FIG. 2 is a diagram illustrating a structure of an MDT measurement according to the related art.

Referring to FIG. 2, Element Management (EM) node 201 sends a trace activation request message to a network element node 202, which may be an eNB in a Long Term Evolution (LTE) system, and MDT configuration information may be included in the message. The MDT configuration information mainly includes information, such as an MDT position selection condition, a reporting mechanism configuration, a Trace Reference (TR), an Internet Protocol (IP) address of a Trace Collection Entity (TCE), a work type, MDT data anonymity, and the like. The above work type may be configured into one of four types: an Immediate MDT only, a Logged MDT only, Trace only, and an Immediate MDT and Trace. The MDT position selection condition configures UEs in what positions may be selected as users of MDT measurement. The position selection condition may be configured as a scope of a Cell, a scope of Total Access Communication system (TAC), or the whole PLMN. UEs within the scope may be selected as UEs of an MDT. The TR uniquely identifies an MDT process. In an MDT process, the eNB may select multiple users to perform MDT measurement.

The network node 202 selects a UE 203 to perform the MDT measurement. When an eNB selects the UE 203, user consent information sent from the MME and the position selection condition in the MDT configuration information should be considered. If the UE 203 does not agree with the MDT, or if the UE 203 does not meet the position selection condition, the UE 203 could not be selected as the UE 203 of the MDT. After the UE 203 is selected, the eNB assigns a Trace Recoding Session Reference (TRSR) for the UE 203. The eNB sends MDT configuration information to the UE 203. The configuration information includes the position selection condition, reporting mechanism configuration, a TR, an identifier of the TCE IP address, and the like.

The UE 203 performs MDT measurement according to the configuration, and sends a measurement result to the eNB when meeting a reporting condition. The eNB will send a Cell Traffic Trace message to an MME 205. The eNB obtains TR, TRSR, the identifier of the TCE IP address, and the measurement result, from the measurement report reported by the UE 203, and sends the Cell Traffic Trace message to the MME 205. The message may include TR, TRSR, an identifier of the Cell, an S1AP ID assigned for the UE 203 by the eNB/MME, the TCE IP address, and the like. MME 205 searches out an International Mobile Subscriber Identity (IMSI) or an International Mobile station Equipment Identity (IMEI) Software Version (SV) of the UE 203, and sends the IMSI/IMEI (SV) to a TCE 204.

The network node 202 preserves MDT records, and according to a predefined policy, searches out the corresponding TCE IP address according to the identifier of the TCE IP address sent by the UE 203. A relationship between the identifier of the TCE IP address and the corresponding TCE IP address is previously stored on eNB. The eNB sends MDT records to the TCE 204, then the TCE 204 may know that the MDT records aims at what UEs combining with information sent by the MME 205.

The MDT types supported by the signaling-based MDT are the same as the aforementioned four types. The differences are that an MDT start message is sent from the MME to the eNB, configuration information is sent from the MME to the eNB, and that TR and TRSR are assigned by the MME. When a UE moves among different eNBs, MDT configuration information needs to be transmitted to a target eNB. However, the MDT configuration information of the management-based MDT does not need to be transmitted to the target eNB.

The present protocols support that the MDT measurement and reporting are performed only in the same PLMN. A PLMN has a PLMN identifier, which includes a Mobile Country Code (MCC) and a Mobile Network Code (MNC). An Equivalent PLMN (EHPLMN) of UE is subscription information of the UE, and is sent to the MME by the HSS. The EHPLMN is a PLMN whose PLMN identifier includes the same MCC and MNC with the MCC and MNC included in the UE IMSI. The EHPLMN is a group of PLMN identifiers, wherein when a UE selects a PLMN, the PLMNs in the group are in an equivalent position with the HPLMN, and this EHPLMN list is stored in the UE and the HSS.

A UE receives a network MDT measurement configuration in a Cell under a PLMN, and saves the configuration, and this PLMN is called an MDT-PLMN. When the UE enters an idle mode and meets the measurement conditions of MDT configuration, the idle mode starts to perform MDT measurement, and saves the measurement results in MDT records of the UE. When moving to a Cell under another PLMN, the UE finds that the PLMN identifier of the selected Cell is different from the PLMN identifier (i.e., MDT-PLMN) configuring the MDT measurement, and the UE neither performs the MDT measurement nor reports the measurement results to the network. Only when entering into a Cell under the MDT-PLMN, the UE may report the MDT measurement. The Network end only supports the MDT measurement under a PLMN, and if an eNB finds that a PLMN identifier included in a TR of a message requesting for MDT initiation is different from the identifier supported by the eNB, the eNB will ignore the request. For management-based MDT, when a UE performs an X2 handover, a source eNB sends the user consent information to a target eNB only when a destination PLMN identifier is the same with an original identifier. When the target eNB belongs to another PLMN, the target eNB does not have the user consent information, and the eNB could not select the UE to perform MDT measurement.

An operator may have multiple PLMN identifiers and the operator hopes that the MDT measurement of a UE could continue within a scope of an operator. More particularly, when the UE moves to another PLMN, this PLMN and the original PLMN belong to the same operator, and the MDT measurement could be performed continuously and may be reported to the network. In order to support this feature, it needs to modify the current protocols.

For a management-based MDT, in order to let a UE be selected as an MDT UE under other PLMNs, the user consent information needs to be transmitted to an eNB under other PLMNs when the UE moves to the eNB under other PLMNs. There are two transmission methods, one is to send the user consent information to a target eNB by the MME, and the other is to send the user consent information to the target eNB by a source eNB. The latter requires that the source eNB saves the PLMNs under which the user may support the MDT measurement, wherein the PLMN list is called an MDT PLMN list. According to the current definition, if a PLMN supported by the target eNB is in the MDT PLMN list, then the source eNB sends the user consent information to the target eNB. If the target eNB is not in the MDT PLMN list, then the source eNB does not send the user consent information to the target eNB. However, this method may lead to loss of the user consent information during transmission. For example, a UE moves from an eNB1 to an eNB2, the eNB1, and not the eNB2, belongs to the scope of the MDT PLMN, and the eNB1 does not send the user consent information to the eNB2. When the UE moves to an eNB3 and the eNB3 belongs to the scope of the MDT PLMN, if the eNB3 could not receive the user consent information, the eNB3 does not know whether it is because the user does not have the user consent information, or if the user consent information is lost during transmission.

The UE may perform MDT measurement either in an idle mode or in a connection mode. If the MDT measurement configuration is to configure the UE to perform MDT measurement in the idle mode, then a record type MDT (i.e., a Logged MDT) is called. In order to support the UE to perform MDT measurement and reporting under multiple PLMNs, when the UE performs Logged MDT measurement, the following circumstance may occur. When performing MDT measurement, if an idle UE moves to another PLMN, wherein the PLMN belongs to the MDT PLMN list, then the UE may continue to perform the MDT measurement. If the UE enters into the connection mode, when establishing the RRC connection, the UE reports an MDT measurement indication to the network. After receiving the indication, the eNB may send an RRC message to request the UE to report the MDT measurement record. The correct process is that after receiving the measurement record, the eNB searches out a TCE IP address, and sends the measurement record to an entity corresponding to the TCE IP. However, if a version of the eNB is different from that of the UE, i.e., if the eNB is an old version, and does not support a number of MDT PLMNs, the eNB only saves TCE IP addresses of the PLMNs for which the eNB serves and does not save TCE IP addresses of other PLMNs, the eNB should discard the MDT record reported by the UE, and after the UE sends the record to the eNB, the MDT record in UE side will be also discarded. Therefore, when an idle UE performs Logged MDT measurement, the MDT record saved by the UE may be discarded due to a report, while the eNB discards the MDT record reported by the UE, wherein the MDT record of the corresponding UE in a system is lost.

Therefore, a need exists for a method of preventing loss of user consent information during transmission through MDT continuous measurement under multiple PLMNs.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method of Minimization of Drive Tests (MDT) continuous measurement under multiple Public Land Mobile Networks (PLMNs, which could avoid the loss of user consent information during transmission.

Another aspect of the present invention is to provide a method of MDT measurement reporting under multiple PLMNs for preventing loss of MDT records of a User Equipment (UE).

In accordance with an aspect of the present invention, a method of MDT continuous measurement under multiple PLMNs is provided. The method includes sending, by a Mobile Management Entity (MME), user consent information of a UE and a corresponding MDT PLMN list to an evolved Node B (eNB) of a cell where the UE is located, and when the UE performs an X2 handover, sending, by a source eNB, the user consent information of the UE and the MDT PLMN list to a target eNB without determining whether a PLMN identifier selected by the UE is in the MDT PLMN list of the UE.

The sending of the user consent information of the UE and the MDT PLMN list includes the source eNB including the user consent information of the UE and the MDT PLMN list into a handover request message which is sent to the target eNB.

The method further includes, according to saved user consent information of the UE and the MDT PLMN list, as well as MDT configuration information, determining, by the target eNB, whether it is needed to continue to perform the MDT measurement, when it is determined that the MDT measurement is performed continuously, including, by the target eNB, a Radio Resource Control (RRC) message into a handover response message, which is sent to the source eNB, to release configuration of the MDT measurement, and forwarding, by the source eNB, the RRC message to the UE.

The MME sends the user consent information of the UE and the MDT PLMN list to the eNB through at least one of an S1 handover request message and an initial context establishment request message of the UE.

The method further includes at least one of, adding the MDT PLMN list into at least one of the user consent information of the handover request message and the initial context establishment request message of the UE, in at least one of a handover limitation list of the handover request message and the initial context establishment request message of the UE, correspondingly adding an indication for each PLMN identifier in the handover limitation list indicating whether the UE under a corresponding PLMN agrees to perform the MDT measurement, and in at least one of the handover request message and the initial context establishment request message of the UE, each PLMN identifier in the handover limitation list indicating whether the UE under the corresponding PLMN agrees to perform the MDT measurement through whether it correspondingly adds a customized indication.

In accordance with another aspect of the present invention, a method of MDT continuous measurement under multiple PLMNs is provided. The method includes, sending, by an MME, user consent information of a UE and a corresponding MDT PLMN list to an eNB of a cell where the UE is located, when an X2 handover is performed, determining, by a source eNB, whether a PLMN identifier selected for the UE is in the MDT PLMN list of the UE, wherein, if it is determined that the PLMN identifier selected for the UE is in the MDT PLMN list of the UE, the source eNB including the user consent information of the UE and the MDT PLMN list into a handover request message, which is sent to a target eNB, and if it is determined that the PLMN identifier selected for the UE is not in the MDT PLMN list of the UE or the source eNB does not have the user consent information of the UE.

The method further includes, including, by the source eNB, the MDT PLMN list into the transmitted handover request message without including the user consent information of the UE, when the target eNB determines that a destination service PLMN is included in the MDT PLMN list of the UE and does not receive the user consent information of the UE, requesting, by the target eNB, for the MME to send the user consent information of the UE to the target eNB, and after receiving the request, sending, by the MME, the user consent information of the UE to the target eNB.

The requesting for the MME to send the user consent information of the UE includes, adding an indication message indicating that the MME sends the user consent information of the UE to the target eNB into a route handover request message, which is sent to the MME, wherein the MME sending the user consent information of the UE to the target eNB comprises, if the route handover request message received by the MME includes the indication, including, by the MME, the user consent information of the UE into a route handover request response message which is sent to the target eNB.

The determining of whether the PLMN identifier selected for the UE is in the MDT PLMN list of the UE further includes, when the X2 handover is performed, including, by the source eNB, a PLMN identifier used by the UE in the source eNB into the handover request message, which is sent to the target eNB, and determining whether the PLMN identifier used by the UE in the source eNB is in the MDT PLMN list of the UE, wherein, if it is determined that the PLMN identifier used by the UE in the source eNB is in the MDT PLMN list of the UE, requesting for the MME to send the user consent information of the UE not being performed, and wherein, if it is determined that the PLMN identifier used by the UE in the source eNB is not in the MDT PLMN list of the UE, the target eNB continues to request for the MME to send the user consent information of the UE.

The MME sends the user consent information of the UE and the MDT PLMN list to the eNB through at least one of the handover request message and an initial context establishment request message of the UE.

The method further includes at least one of adding the MDT PLMN list into at least one of the user consent information of the handover request message and the initial context establishment request message of the UE, and in at least one of a handover limitation list of the handover request message and the initial context establishment request message of the UE, correspondingly adding an MDT indication for each PLMN identifier in the handover limitation list indicating whether a corresponding PLMN is an MDT PLMN and whether the UE under the corresponding PLMN supports the MDT measurement.

In accordance with another aspect of the present invention, a method of MDT measurement reporting under multiple PLMNs is provided. The method includes entering, by a UE, into a connection mode, if the UE has saved an MDT measurement report and a PLMN identifier selected by the UE is different from an MDT-PLMN identifier configuring the UE to perform logged MDT measurement, the UE including indication information indicating that a current UE has saved the MDT measurement report and the measurement report is configured under PLMNs other than a selected PLMN into an RRC connection establishment completion message, which is sent to an eNB of a cell where the UE is currently located, and requesting, by the eNB, for the UE to report the MDT measurement report according to the indication information, and for the UE to send the MDT measurement report.

The requesting for the UE to report the MDT measurement report includes sending, by the eNB, a UE information request message to the UE.

In accordance with another aspect of the present invention, a method of MDT measurement reporting under multiple PLMNs is provided. The method includes entering, by a UE, into a connection mode, if the UE has saved an MDT measurement report, the UE including indication information and a PLMN identifier into an RRC connection establishment completion message, which is sent to an eNB of a cell where the UE is currently located, receiving, by the eNB, the RRC connection completion message, determining, by the eNB, that the UE has saved the MDT measurement report according to the indication information, and determining, by the eNB, whether the eNB has saved an Internet Protocol (IP) address of a Trace Collection Entity (TCE) corresponding to the PLMN indicated by the PLMN identifier, wherein, if it is determined that the eNB has saved the IP address, requesting, by the eNB for the UE to report the MDT measurement report, and sending, by the UE, the MDT measurement report, wherein the indication information indicates that the UE has saved the MDT measurement report, and the PLMN identifier indicates measurement configuration received by the UE under the PLMN.

The method further includes obtaining, by the eNB, the IP address of the TCE corresponding to the PLMN indicated by the PLMN identifier and a corresponding TCE identifier from at least one of an EM and an MME.

The requesting for the UE to report the MDT measurement report includes sending, by the eNB, a UE information request message to the UE, wherein the UE sends a UE information response message to the eNB, and includes the MDT measurement report into the response message, and wherein the eNB does not send the UE information request message to the UE.

As can be seen from the above technical solution, an exemplary method for achieving MDT continuity includes that a source eNB sends MDT-related information, such as user consent information to a target eNB, or the target eNB requests user consent information to an MME, and transmitting of the user consent information among multiple PLMNs without being lost during transmission. Exemplary embodiments of the present invention also provide a method for achieving MDT reporting, wherein the UE reports a new indication message. Alternatively, the UE reports a PLMN identifier where the UE receives the MDT configuration to the eNB, the method enables the eNB to correctly determine whether it is requested for the UE to report the measurement record to the eNB, thereby preventing loss of the MDT measurement report.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a System Architecture Evolution (SAE) according to the related art;

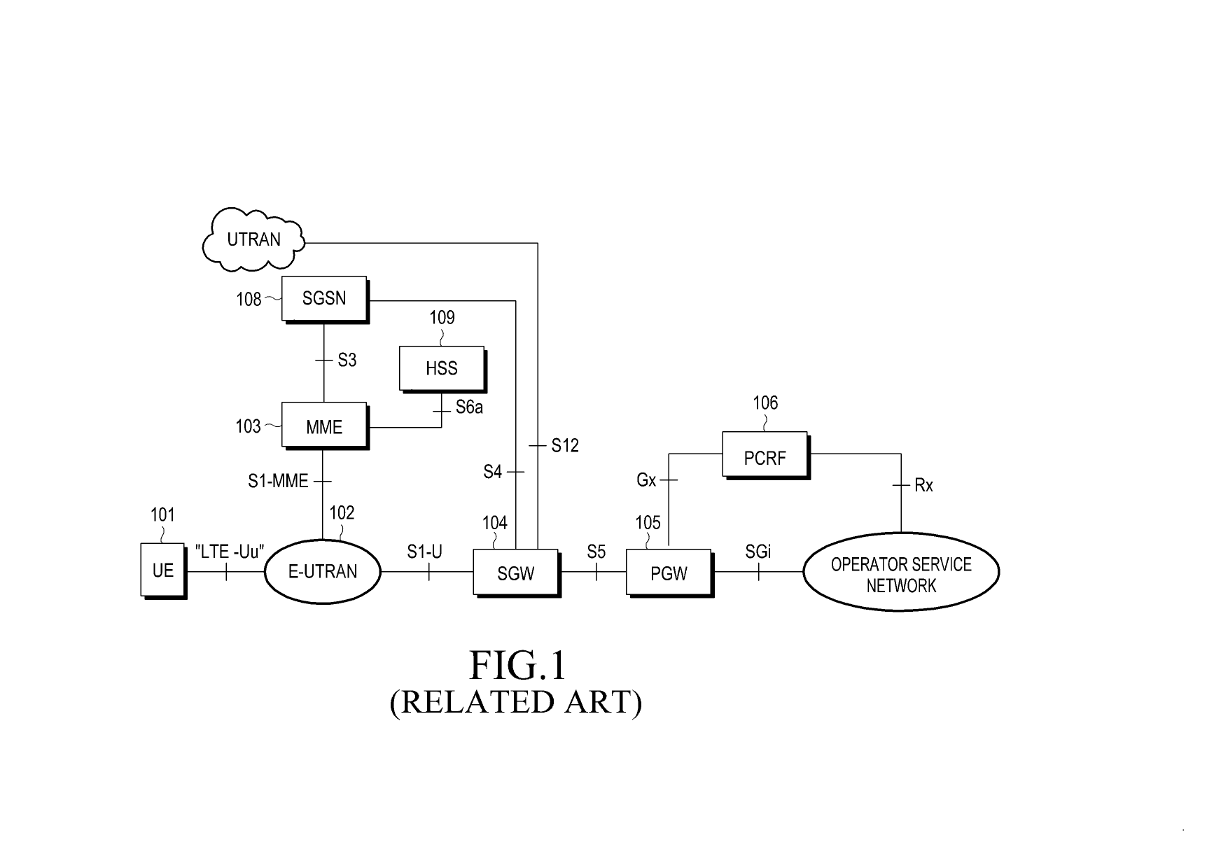

FIG. 2 is a diagram illustrating a structure of Minimization of Drive Tests (MDT) measurement according to the related art;

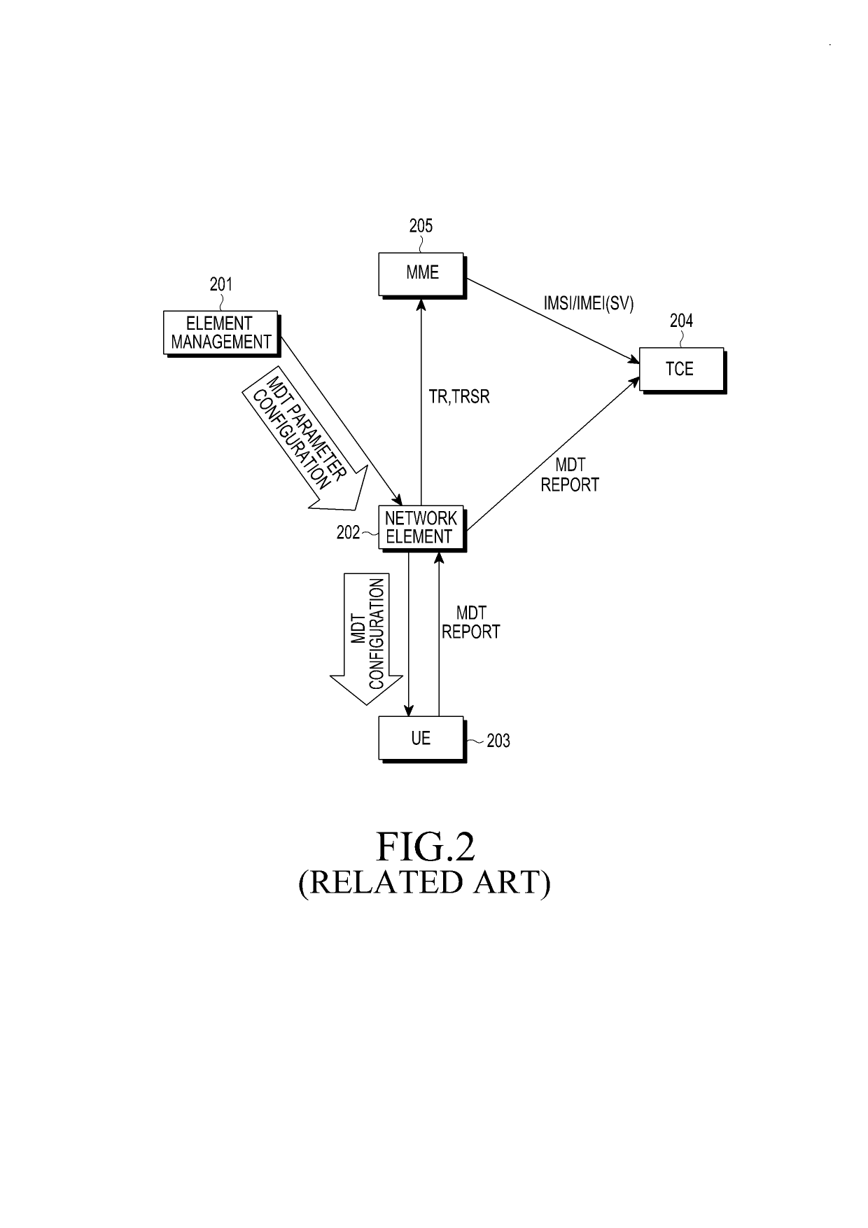

FIG. 3 is a flowchart illustrating MDT continuous measurement for transmitting MDT related information from a source evolved Node B (eNB) to a target eNB according to a first exemplary embodiment of the present invention;

FIG. 4 is a flowchart illustrating MDT continuous measurement for transmitting MDT related information from a source eNB to a target eNB according to a second exemplary embodiment of the present invention; and

FIG. 5 is a flowchart illustrating MDT continuous measurement for transmitting MDT related information from a source eNB to a target eNB according to a third exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In order to prevent loss of user consent information during transmission among different Public Land Mobile Networks (PLMNs), the following description of the present invention provide two exemplary methods (i.e., exemplary methods 1 and 2 below) for supporting Minimization of Drive Tests (MDT) continuous measurement.

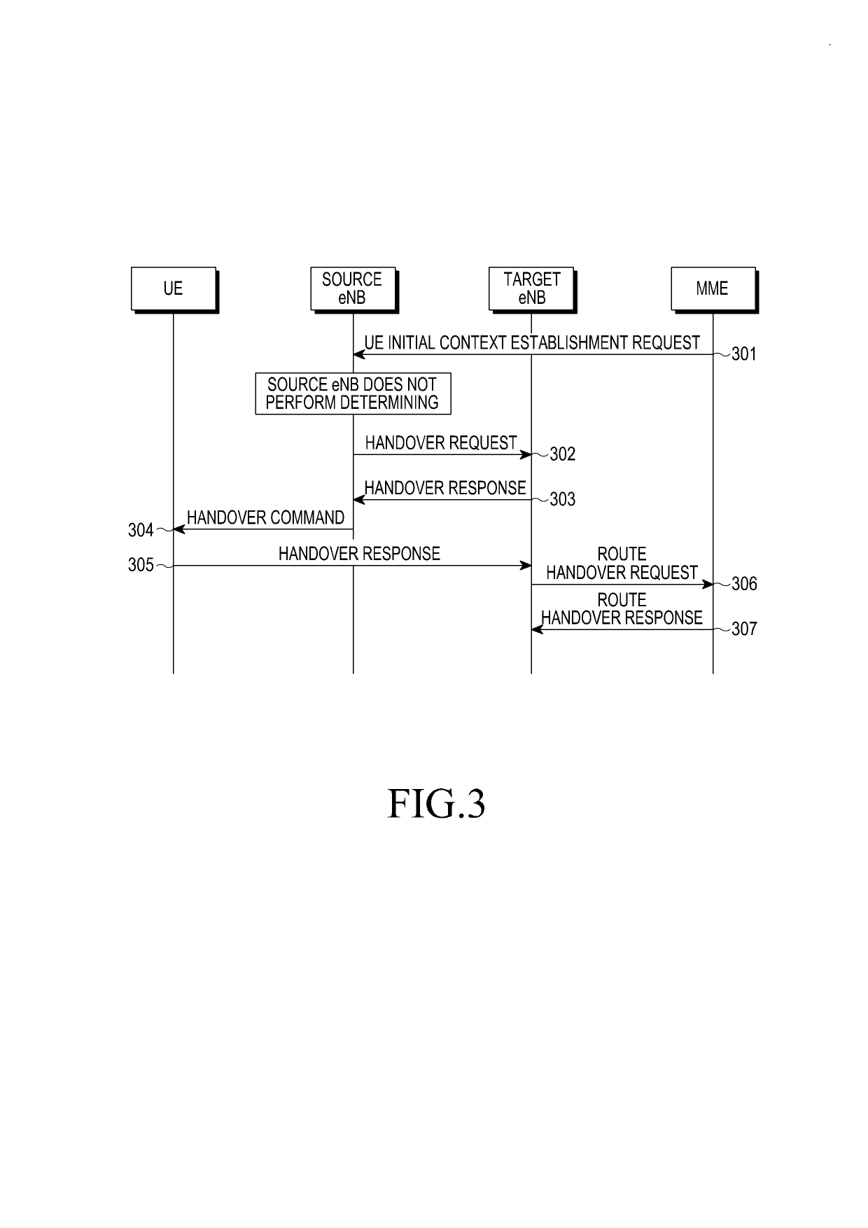

FIGS. 3 through 5, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

### Exemplary Embodiment 1

A Mobile Management Entity (MME) sends user consent information and an MDT PLMN list to an evolved Node B (eNB), when an X2 handover is performed, a source eNB does not need to determine whether a service PLMN selected for a UE and used in a target eNB is in the MDT PLMN list. A process for forwarding the user consent information and the MDT PLMN list to the target eNB by the source eNB.

FIG. 3 is a flowchart illustrating MDT continuous measurement for transmitting MDT related information from a source eNB to a target eNB according to a first exemplary embodiment of the present invention.

Referring to FIG. 3, in step 301, an MME sends an MDT PLMN list of a User Equipment (UE) and corresponding user consent information of the UE to an eNB of a Cell where the UE is located.

Moreover, in step 301, the MME sends the MDT PLMN list and the user consent information to the eNB of the Cell where the UE is located. Specifically, the eNB of the Cell where the UE is located is an eNB of a Cell where the UE is located when an initial connection is established, or a target eNB of an S1 handover performed by the UE. The MDT PLMN list and the corresponding user consent information are transmitted through the following exemplary methods.

Exemplary Method 1: The MME transmits, through a UE initial context establishment request message, the MDT PLMN list and the corresponding user consent information to the eNB of the Cell where the UE is located when the initial connection is established. The specific transmission schemes are described below.

Currently, the UE initial context establishment request message includes information, such as an identifier of the UE on an S1 interface, Evolved-Radio Access Bearer (E-RAB) information to be established, a UE encryption capability, a handover limitation list, a UE radio capability, user consent information, and the like. In an exemplary embodiment, an MDT PLMN list is added into the user consent information. If the MDT PLMN list is set up, it is indicated that the network and the UE may continuously perform MDT measurement under the systems indicated by the MDT PLMN list. Alternatively, in the handover limitation list, a customization indication is added for each PLMN in the corresponding list, which indicates whether the user agrees to perform the MDT measurement under the PLMN, and whether the PLMN is an MDT PLMN. If the indication is set as an agreement, it is indicated that the PLMN is an MDT PLMN and the user agrees to perform the MDT measurement under the PLMN. In contrast, if the indication is set as a non-agreement, it is indicated that the PLMN is not an MDT PLMN and the user does not agree to perform the MDT measurement under the PLMN. Alternatively, in the handover limitation list, each PLMN in the corresponding list indicates if the UE under the corresponding PLMN agrees to perform the MDT measurement by adding a new indication. For example, if the customization indication is set up under the corresponding PLMN identifier, it is indicated that the PLMN is an MDT PLMN and the user agrees to perform the MDT measurement under the PLMN. In contrast, if the customization indication is not set up under the corresponding PLMN identifier, it is indicated that the PLMN is not an MDT PLMN and the user does not agree to perform the MDT measurement under the PLMN. The above transmission schemes for carrying the MDT PLMN list and the user consent information are described in Table 1 and Table 2 respectively.

TABLE 1
UE initial context establishment request:

> user consent information
>MDT PLMN list
>>PLMN identifier

TABLE 2
UE initial context establishment request:

> handover limitation list
>>equivalent PLMN list
>>> PLMN identifier
>>>whether support MDT indication or not

Exemplary Method 2: The MME transmits, through an S1 handover request message, the MDT PLMN list and the corresponding user consent information to a target eNB of the S1 handover. The specific transmission schemes are described below.

Currently, the S1 handover request message includes information, such as an identifier of the UE on an S1 interface, E-RAB information to be established, UE encryption capability, a handover limitation list, UE radio capability, user consent information, and the like. In an exemplary embodiment, an MDT PLMN list may be added into the user consent information. If the MDT PLMN list is set up, it is indicated that the network and the UE may continuously perform MDT measurement under the systems indicated by the MDT PLMN list. Alternatively, in the handover limitation list, a customization indication is added for each PLMN in the corresponding list, which indicates whether the user agrees to perform the MDT measurement under the PLMN, and whether the PLMN is an MDT PLMN. If the indication is set as an agreement, it is indicated that the PLMN is an MDT PLMN and the user agrees to perform the MDT measurement under the PLMN. In contrast, if the indication is set as a non-agreement, it is indicated that the PLMN is not an MDT PLMN and the user does not agree to perform the MDT measurement under the PLMN. Alternatively, in the handover limitation list, each PLMN identifier in the corresponding list indicates if the UE under the corresponding PLMN agrees to perform the MDT measurement adding a new indication. For example, if the customization indication is set up under the corresponding PLMN identifier, it is indicated that the PLMN is an MDT PLMN and the user agrees to perform the MDT measurement under the PLMN. In contrast, if the customization indication is not set up under the corresponding PLMN identifier, it is indicated that the PLMN is not an MDT PLMN and the user does not agree to perform the MDT measurement under the PLMN. The above transmission schemes of carrying the MDT PLMN list and the user consent information are described in Table 1 and Table 2, respectively.

If an eNB receives MDT measurement configuration information sent by the entity EM 201, the eNB selects some UEs to perform MDT measurement. When selecting the UEs, the eNB needs to consider three factors: the user consent information, coverage area information within the MDT configuration information, and the MDT PLMN list. Only when a PLMN identifier of the eNB is in the MDT PLMN list of the UE, the user agrees to perform the MDT measurement, a Cell where the UE is currently located is in the coverage area within the MDT configuration information, and the UE may be selected as a UE to perform the MDT measurement.

Accordingly, before X2 handover, the MME sends the user consent information and MDT PLMN list information to the eNB of the Cell where the UE is located. Consequently, before the X2 handover, the eNB of the Cell where the UE is located saves the user consent information and MDT PLMN list information, namely the source eNB of X2 handover saves the user consent information and MDT PLMN list information.

In step 302, the eNB receives a measurement report of the UE, and needs to switch the UE to the target eNB according to the measurement report of the UE. There exists an X2 interface between the source eNB and the target eNB, wherein the source eNB initiates an X2 handover process. The source eNB sends a handover request message to the target eNB selects an PLMN identifier used in the target eNB for the UE, does not need to determine whether the destination service PLMN belongs to the MDT PLMN list, includes the user consent information and the MDT PLMN list information in the handover request message, and sends the message to the target eNB.

The MDT PLMN list and the user consent information are included in the handover request message and sent to the target eNB. The MDT PLMN list and the user consent information may also be carried through other existing messages or new customized messages.

When each X2 handover is performed, the source eNB will send the MDT PLMN list and the user consent information to the target eNB. Accordingly, the eNB where the user is located will save the MDT PLMN list and the user consent information, so that it could ensure that the source eNB saves the MDT PLMN list and the user consent information, which may be transmitted to the source eNB during each X2 handover.

In step 303, the target eNB saves the received MDT PLMN list and the user consent information, and sends a handover response message to the source eNB. The message includes information about E-RAB, which may be established by the target eNB, and includes the RRC message sent to the UE through the source eNB.

If the handover request message received by the target eNB includes RRC configuration information for the UE, which may include RRC measurement configuration information, and if it is configured in the source eNB that the UE performs MDT measurement, the target eNB needs to determine whether it is needed to continue to perform the MDT measurement. Only when the destination service PLMN identifier is in the MDT PLMN list of the UE and the Cell where the UE is currently located is in the coverage area within the MDT configuration information, the target eNB continues to receive the MDT report sent by the UE without releasing the MDT measurement configuration of the UE. If the destination service PLMN identifier is not in the MDT PLMN list of the UE, the target eNB includes an RRC message into the handover response message to release the MDT measurement configuration of the UE, wherein the RRC message is transmitted to the UE by the source eNB.

In step 304, the source eNB sends a handover command to the UE. The message includes all information needed for handover to the target eNB, such as encryption information, channel parameters, and the like.

In step 305, after synchronizing with the destination Cell, the UE sends the handover response message to the target eNB. Uplink data and downlink data may be transmitted in the air interface.

In step 306, the target eNB sends a route handover request message to the MME. The message includes an identifier of the UE on the S1 interface and a Target Area Identifier (TAI), which includes information, such as a selected destination service PLMN identifier, tunnel numbers distributed by the eNB for the downlink data, and the like.

In step 307, the MME sends a route handover response message to the target eNB. The message includes information, such as an identifier of the UE on the S1 interface, tunnel numbers distributed by the core network for the uplink data, and the like. Thereafter, the X2 handover process is completed.

According to exemplary embodiment 1, during X2 handover, on the one hand, no matter whether the PLMN used by the UE in the target eNB is within the MDT PLMN list, the source eNB will directly send the MDT PLMN list and the user consent information to the target eNB to prevent loss of user consent information. On the other hand, information transmission is achieved during the handover to prevent release of the MDT measurement when the user consent information is transmitted after the handover is completed.

### Exemplary Embodiment 2

An eNB of a Cell where a UE is located saves user consent information and an MDT PLMN list, during X2 handover, according to the MDT PLMN list. A source eNB determines whether a destination service PLMN is in the MDT PLMN list of a user, then determines whether it is requested for the source eNB to send the user consent information to the target eNB.

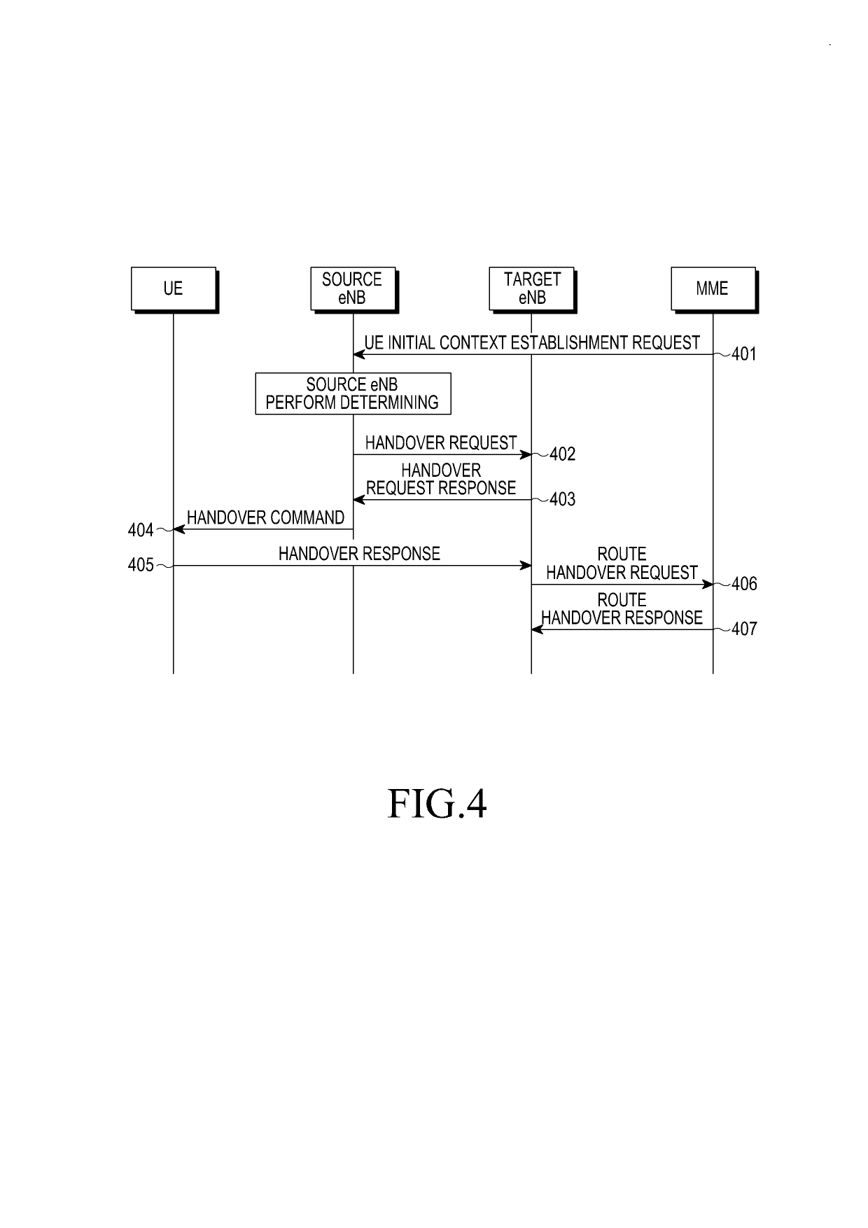

FIG. 4 is a flowchart illustrating MDT continuous measurement for transmitting MDT related information from a source eNB to a target eNB according to a second exemplary embodiment of the present invention.

Referring to FIG. 4, in step 401, an MME sends user consent information and an MDT PLMN list to a source eNB of a Cell where the UE is located.

Specifically, the MME may either use a transmission scheme of the related art or of the aforegoing first exemplary embodiment to send the user consent information and the MDT PLMN list to the eNB.

In step 402, the eNB receives a measurement report of the UE, and needs to handover the UE to the target eNB according to the measurement report of the UE. The source eNB selects a destination service PLMN identifier for the UE. If the source eNB saves the user consent information and the MDT configuration information, and the destination service PLMN is in the scope of the MDT PLMN, then the source eNB sends a handover request message to the target eNB, which includes the user consent information and the MDT configuration information. If the destination service PLMN is not in the scope of the MDT PLMN, or the source eNB does not have the user consent information and the MDT configuration information, then the source eNB sends the handover request message to the target eNB, which does not include the user consent information and the MDT configuration information. Regardless of the presence of the destination service PLMN identifier in the MDT PLMN list, the handover request message sent from the source eNB to the target eNB will include the MDT PLMN list of the UE.

As can be seen from the above second exemplary embodiment of the present invention, only when the source eNB saves the user consent information itself, and the destination service PLMN identifier is in the MDT PLMN list, the source eNB will send the user consent information to the target eNB. Consequently, the user consent information may be lost during multiple transmissions of X2 handover. Accordingly, the source eNB does not have user consent message in this step and may be caused either by the loss of user consent message during transmission, or by the user not agreeing to perform MDT measurement on the corresponding PLMN.

In step 403, the target eNB sends a handover response message to the source eNB. The message includes information about bearers, which may be established, and a transparent transmission container from the destination to the original, which includes messages to be transmitted to the UE.

In step 404, the source eNB sends a handover command to the UE. The message includes all information needed during handover to the target eNB, such as encryption information, channel parameters, and the like.

In step 405, after synchronizing with the destination Cell, the UE sends the handover response message to the target eNB. Uplink data and downlink data may be transmitted

In step 406, the target eNB sends a route handover request message to the MME. The message includes a TAI, which includes a selected destination service PLMN identifier. If the destination service PLMN identifier is in the MDT PLMN, and the user consent information is not obtained in step 402, then the route handover request message will include an indication message indicating that the MME needs to send the user consent information to the eNB.

In step 407, the MME sends a route handover response message to the target eNB. According to the indication of step 405, the message may include the user consent information. Thereafter, the X2 handover process is completed.

In the above step 406, the user consent information not being received may be caused either by the loss of user consent information resulting from the PLMN used by the UE in the source eNB not being in the MDT PLMN list, or by the PLMN used by the UE in the source eNB being in the MDT PLMN list but the user not agreeing to perform MDT measurement under the corresponding PLMN in the MDT PLMN list. If it is the latter, even if the target eNB requests the user consent information to the MME through the route handover request, the MME will not send the user consent information to the target eNB, which may result in redundant transmission of the indication information.

To address the above problems, an enhanced method of the second exemplary embodiment of the present invention may include a service PLMN identifier used by the UE in the source eNB, besides a destination service PLMN identifier selected by the source eNB, for the UE and the MDT PLMN list into the handover request message in step 402. In step 402, the target eNB receives the MDT PLMN list, and determines whether the service PLMN identifier used by the UE in the source eNB is in the MDT PLMN list before the route request message including the indication information is sent in step 406. If it is determined that the service PLMN identifier used by the UE in the source eNB is not in the MDT PLMN list and the destination service PLMN is in the MDT PLMN list, it is indicated that the user consent information is lost during transmission. At this time, the target eNB includes an indication in the route handover request message of step 406, which indicates that the MME needs to send the user consent information to the eNB. Other steps are the same with those of the second exemplary embodiment of the present invention. If the service PLMN identifier used by the UE in the source eNB is in the MDT PLMN list, then the user consent information is not obtained since the user does not agree to perform MDT measurement under the corresponding PLMN. Accordingly, the target eNB does not need to carry the aforegoing indication information when sending the route handover request message, so that the redundant transmission of the indication information is prevented. By the above enhanced exemplary method, it could identify whether the reason for not receiving the user consent information is due to loss during transmission. Consequently, redundant transmission of the indication information may be prevented.

It can be seen from the above-mentioned exemplary embodiments of the present invention, which support MDT continuous measurement, that the eNB sends the MDT-related information to the target eNB or the target eNB requests the user consent information from the MME and transmits the user consent information among multiple PLMNs without being lost during transmission.

An exemplary implementation of an MDT measurement reporting of the UE is described below. By this form of reporting, loss of the UE measurement report may be prevented.

### Exemplary Embodiment 3

The UE enters into the connection mode. If the UE stored an MDT measurement report, the UE reports an indication to the network to indicate that the UE has the MDT measurement report and the eNB may send messages to the UE. Thereafter, the UE reports the measurement to the eNB.

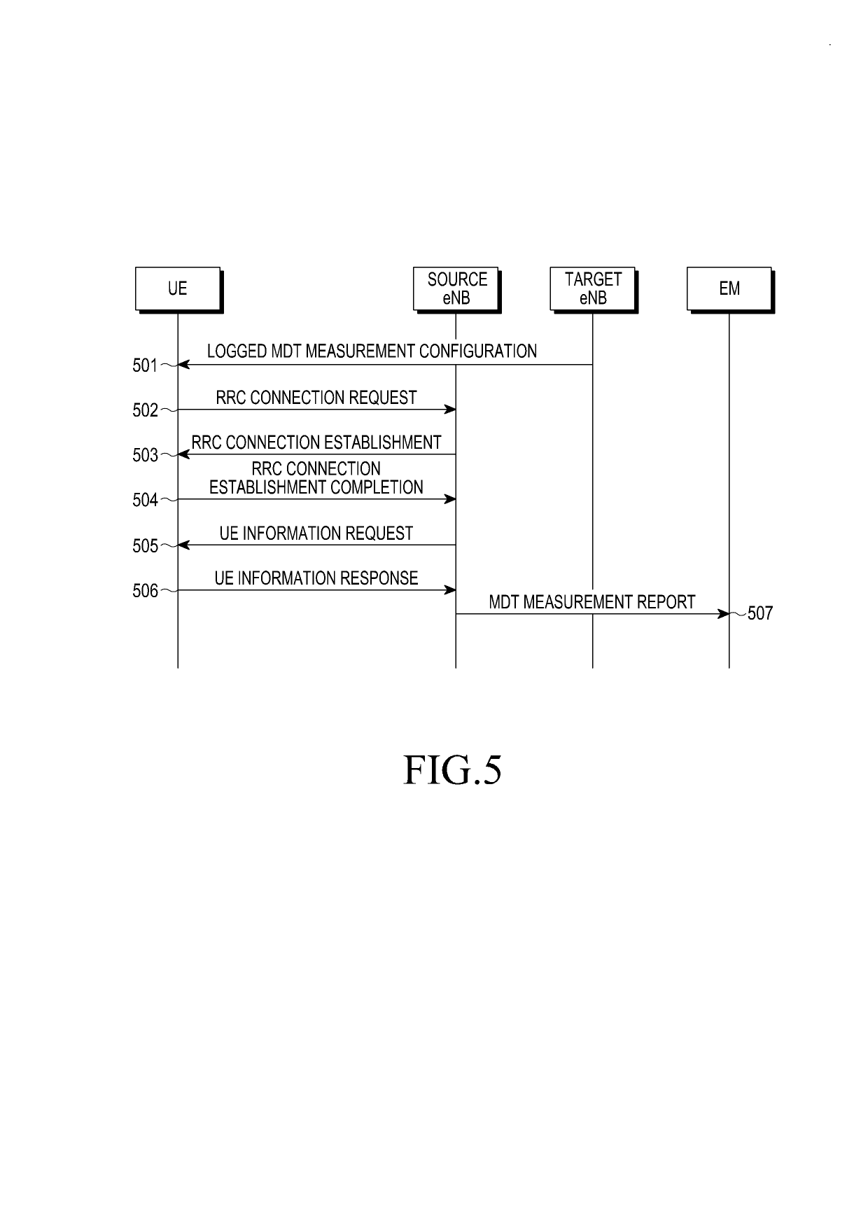

FIG. 5 is a flowchart illustrating MDT continuous measurement for transmitting MDT related information from a source eNB to a target eNB according to a third exemplary embodiment of the present invention.

Referring to FIG. 5, in step 501, in a connection mode, a UE resides in a Cell under a PLMN, and a target eNB sends a Logged measurement configuration message to the UE. The Logged MDT measurement configuration message may include TR, TRSR, an indication of TCE, measurement conditions, measurement scope, and the like. A PLMN identifier is included in the TR, called an MDT-PLMN identifier, and is stored in the UE. An MDT PLMN list is configured for the UE and indicates within which PLMNs' scope the UE may continue to perform the MDT measurement. The MDT PLMN list may either be configured in step 501, or be configured through a non-access layer.

Thereafter, the UE enters an idle mode. When Logged MDT measurement conditions are met, the MDT measurement is performed and a measurement result is saved in the measurement report, which is saved in the UE. A UE in the idle mode may move to other PLMNs. If a service PLMN identifier of a Cell where the UE resides belongs to the MDT list, and a coverage area of MDT configuration is met, the UE may continue to perform the MDT measurement, and saves the measurement result to the MDT measurement report of the UE.

In step 502, the UE, needing to enter into the connection mode and establish a radio access connection, sends an RRC connection request message to the source eNB. The message includes an identifier of the UE and a reason for RRC establishment.

In step 503, the source eNB sends an RRC connection establishment message to the UE, wherein the message includes radio resource allocation.

In step 504, the UE sends an RRC connection establishment completion message to the source eNB, which includes indication information indicating that the UE saves the MDT measurement report, and configures that the PLMN of the measurement is different from the PLMN selected by the UE.

The UE then enters into the connection mode. The message includes the PLMN identifier selected by the UE and non-access layer messages. The message also includes indication information. The source eNB recognizes that the UE has saved the MDT measurement report through the indication information. The third exemplary embodiment of the present invention gives two exemplary methods of the indication information described below.

Exemplary Method 1: If the PLMN identifier selected by the UE is the same as the MDT-PLMN identifier configuring the UE to perform MDT measurement, the UE includes an indication that logged MDT is available (referred to as Indication 1 hereafter) into the RRC connection establishment completion message, wherein the Indication 1 is a currently-defined indication. If the PLMN identifier selected by the UE is different from the MDT-PLMN of the UE but belongs to the MDT PLMN list, then the UE includes an Indication 2 into the message to indicate that the UE has saved the MDT measurement, and the PLMN configuring the measurement is different from the PLMN selected by the UE. In this exemplary method, it is assumed that an IP address and a TCE identifier of TCE corresponding to each PLMN are saved in the eNB. Therefore, as long as the Indication 2 could be correctly parsed out, the MDT measurement report reported by the UE could be sent to the TCE corresponding to the MDT-PLMN.

Exemplary Method 2: If the selected PLMN identifier is the same as the MDT-PLMN identifier configuring the UE to perform MDT measurement, the UE includes an indication that logged MDT is available into the RRC connection establishment completion message, i.e., the above-mentioned Indication 1. If the PLMN identifier selected by the UE is different from the MDT-PLMN of the UE but belongs to the MDT PLMN list, then the Indication 1 is included in the RRC connection establishment completion message, and the RRC connection establishment completion message may further include the MDT-PLMN identifier configuring the UE to perform MDT measurement. In this exemplary method, after parsing out the Indication 1, the eNB still needs the MDT-PLMN identifier to ensure that the MDT measurement report reported by the UE could be sent by the eNB to the TCE corresponding to the MDT-PLMN.

In step 505, the source eNB receives the indication information included in the RRC establishment completion message, and sends a UE information request message to the UE to request for the UE to report the measurement report.

If the indication information is transmitted in accordance with the exemplary method 1 in the above step 504, it is assumed that the source eNB receives the Indication 1 in the RRC establishment completion message, the Indication 1 indicates that the UE has saved the MDT measurement report, and the Indication 1 is an information element in the currently-defined RRC establishment request message. Thereafter, either an eNB with an old version or an eNB with a new version may correctly parse the Indication 1, and the eNB may send the UE information request message to the UE to request that the UE sends the MDT measurement report to the eNB.

It is assumed that the eNB receives the Indication 2 in the RRC establishment completion message, the Indication 2 is a newly-added information element, and the eNB with the old version could not correctly parse the Indication 2. After receiving Indication 2, the eNB with the old version will not send the UE information request message because it could not correctly decode the Indication 2. In this case, the UE will not report the MDT measurement report and will not delete the MDT measurement saved by itself either. The eNB with the new version could correctly parse the Indication 2 after receiving the Indication 2, and the eNB may send the UE information request message to the UE to request for the UE to send the MDT measurement report to the eNB.

If the indication information is transmitted in accordance with the exemplary method 2 in the above step 504, it is assumed that an eNB receives an indication in the RRC establishment completion message and an MDT-PLMN identifier, and the eNB may determine whether an IP address of the TCE corresponding to the MDT-PLMN is saved by itself. If the eNB has saved the IP address of the TCE corresponding to the MDT-PLMN, the eNB may send the UE information request message to the UE to request for the UE to send the MDT measurement report to the eNB. If the eNB has not saved the IP address of the TCE corresponding to the MDT-PLMN, then the eNB does not send the UE information request message. Subsequently, the eNB may initiate a process, in which the eNB requests, towards an EM or an MME, to obtain the IP address of the TCE corresponding to the MDT-PLMN. The EM or MME sends a response message to notify the IP address of the corresponding TCE and a corresponding TCE identifier to the eNB. After obtaining the IP address of the TCE corresponding to the MDT-PLMN, the eNB may send the UE information request message to the UE to request for the UE to send the MDT measurement report to the eNB.

In step 506, the UE sends a UE information response message, which includes the MDT measurement report. The MDT measurement report includes TR, TRST and a TCE identifier of the MDT measurement, wherein the TR includes a PLMN identifier. According to the PLMN identifier in the TR and the TCE identifier, the source eNB may search for the IP address corresponding to the TCE, and send the MDT measurement report of the UE to the TCE through step 507 within a predefined time.

It can be seen from the above-mentioned exemplary embodiments of the present invention, which support MDT continuous measurement, that the UE sends a new indication message indicating that the UE has saved the MDT measurement report, and also indicating that the PLMN where the UE receives the MDT measurement configuration is different from UE selected PLMN. Thereafter, the eNB may be able to, according to the indication, determine whether it is requested for the UE to report the measurement report. Alternatively, the UE reports the PLMN identifier where the UE receives the MDT configuration to the eNB. The eNB may then be able to correctly determine whether to request for the UE to report the measurement record to the eNB.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of Minimization of Drive Tests (MDT) continuous measurement under multiple Public Land Mobile Networks (PLMNs), the method comprising:
sending, by a Mobile Management Entity (MME), user consent information of a User Equipment (UE) and a corresponding MDT PLMN list to an evolved Node B (eNB) of a cell where the UE is located; and
if the UE performs an X2 handover, sending, by a source eNB, the user consent information of the UE and the MDT PLMN list to a target eNB without determining whether a PLMN identifier selected by the UE is in the MDT PLMN list of the UE.

2. The method of claim 1, wherein the sending of the user consent information of the UE and the MDT PLMN list comprises:
including, by the source eNB, the user consent information of the UE and the MDT PLMN list into a handover request message which is sent to the target eNB.

3. The method of claim 1, further comprising:
according to saved the user consent information of the UE and the MDT PLMN list, as well as MDT configuration information, determining, by the target eNB, whether it is needed to continue to perform the MDT continuous measurement;
if it is determined that the MDT continuous measurement is performed continuously, including, by the target eNB, a Radio Resource Control (RRC) message into a handover response message, which is sent to the source eNB, to release configuration of the MDT continuous measurement; and
forwarding, by the source eNB, the RRC message to the UE.

4. The method of claim 1, wherein the MME sends the user consent information of the UE and the MDT PLMN list to the eNB through at least one of an S1 handover request message and an initial context establishment request message of the UE.

5. The method of claim 2, wherein the MME sends the user consent information of the UE and the MDT PLMN list to the eNB through at least one of an S1 handover request message and an initial context establishment request message of the UE.

6. The method of claim 3, wherein the MME sends the user consent information of the UE and the MDT PLMN list to the eNB through at least one of an S1 handover request message and an initial context establishment request message of the UE.

7. The method of claim 4, further comprising at least one of:
adding the MDT PLMN list into at least one of the user consent information of the S1 handover request message and the initial context establishment request message of the UE;
in at least one of a handover restriction list of the handover request message and the initial context establishment request message, correspondingly adding an indication for each PLMN identifier in the handover restriction list indicating whether the UE under a corresponding PLMN agrees to perform the MDT continuous measurement; and
in at least one of the handover request message and the initial context establishment request message, each PLMN identifier in the handover restriction list indicating whether the UE under the corresponding PLMN agrees to perform the MDT continuous measurement through whether it correspondingly adds a customized indication.

8. A method of Minimization of Drive Tests (MDT) continuous measurement under multiple Public Land Mobile Networks (PLMNs), the method comprising:
sending, by a Mobile Management Entity (MME), user consent information of a User Equipment (UE) and a corresponding MDT PLMN list to an evolved Node B (eNB) of a cell where the UE is located; and
if an X2 handover is performed, determining, by a source eNB, whether a PLMN identifier selected for the UE is in the MDT PLMN list of the UE,
wherein, if it is determined that the PLMN identifier selected for the UE is in the MDT PLMN list of the UE, the source eNB includes the user consent information of the UE into a handover request message, which is sent to a target eNB, and if it is determined that the PLMN identifier selected for the UE is not in the MDT PLMN list of the UE or the source eNB does not have the user consent information of the UE, the source eNB transmits the handover request message without including the user consent information of the UE.

9. The method of claim 8, further comprising:
requesting, by the target eNB, for the MME to send the user consent information of the UE to the target eNB; and
sending, by the MME, the user consent information of the UE to the target eNB in path switch ACKnowledgement (ACK) message.

10. The method of claim 9, wherein the determining of whether the PLMN identifier selected for the UE is in the MDT PLMN list of the UE further comprises:
if the X2 handover is performed, including, by the source eNB, a PLMN identifier used by the UE in the source eNB into the handover request message, which is sent to the target eNB; and
determining whether the PLMN identifier used by the UE in the source eNB is in the MDT PLMN list of the UE,
wherein, if it is determined that the PLMN identifier used by the UE in the source eNB is in the MDT PLMN list of the UE, requesting for the MME to send the user consent information of the UE not being performed, and
wherein, if it is determined that the PLMN identifier used by the UE in the source eNB is not in the MDT PLMN list of the UE, the target eNB continues to request for the MME to send the user consent information of the UE.

11. The method of claim 8, wherein the MME sends the user consent information of the UE and the MDT PLMN list to the eNB through at least one of the handover request message and an initial context establishment request message of the UE.

12. The method of claim 9, wherein the MME sends the user consent information of the UE and the MDT PLMN list to the eNB through at least one of the handover request message and an initial context establishment request message of the UE.

13. The method of claim 10, wherein the MME sends the user consent information of the UE and the MDT PLMN list to the eNB through at least one of the handover request message and an initial context establishment request message of the UE.

14. The method of claim 11, further comprising at least one of:
adding the MDT PLMN list into at least one of the user consent information of the handover request message and the initial context establishment request message of the UE; and
in at least one of a handover limitation list of the handover request message and the initial context establishment request message of the UE, correspondingly adding an MDT indication for each PLMN identifier in the handover limitation list indicating whether a corresponding PLMN is an MDT PLMN and whether the UE under the corresponding PLMN supports the MDT continuous measurement.

15. A method of Minimization of Drive Tests (MDT) measurement reporting under multiple Public Land Mobile Networks (PLMNs), the method comprising:
entering, by a User Equipment (UE), into a connection mode, if the UE has saved an MDT measurement report and a PLMN identifier selected by the UE is different from an MDT-PLMN identifier configuring the UE to perform logged MDT measurement, the UE including indication information indicating that a current UE has saved the MDT measurement report and the MDT measurement report is configured under PLMNs other than a selected PLMN into a Radio Resource Control (RRC) connection establishment completion message, which is sent to an evolved Node B (eNB) of a cell where the UE is currently is located; and
requesting, by the eNB, for the UE to report the MDT measurement report according to the indication information, and for the UE to send the MDT measurement report.

16. The method of claim 15, wherein the requesting for the UE to report the MDT measurement report comprises:
sending, by the eNB, a UE information request message to the UE.

17. A method of Minimization of Drive Tests (MDT) measurement reporting under multiple Public Land Mobile Networks (PLMNs), the method comprising:
entering, by a User Equipment (UE), into a connection mode, if the UE has saved an MDT measurement report, the UE including indication information and a PLMN identifier into a Radio Resource Control (RRC) connection establishment completion message, which is sent to an evolved Node B (eNB) of a cell where the UE is currently located;
receiving, by the eNB, the RRC connection completion message;
determining, by the eNB, that the UE has saved the MDT measurement report according to the indication information; and
determining, by the eNB, whether the eNB has saved an Internet Protocol (IP) address of a Trace Collection Entity (TCE) corresponding to the PLMN indicated by the PLMN identifier,
wherein, if it is determined that the eNB has saved the IP address, the eNB requests for the UE to report the MDT measurement report, and the UE sends the MDT measurement report, and
wherein the indication information indicates that the UE has saved the MDT measurement report, and the PLMN identifier indicates measurement configuration received by the UE under the PLMN.

18. The method of claim 17, further comprising:
obtaining, by the eNB, the IP address of the TCE corresponding to the PLMN indicated by the PLMN identifier and a corresponding TCE identifier from at least one of an Element Management (EM) and a Mobile Management Entity (MME).

19. The method of claim 17, wherein the requesting for the UE to report the MDT measurement report comprises:
sending, by the eNB, a UE information request message to the UE,
wherein the UE sends a UE information response message to the eNB and includes the MDT measurement report into the UE information response message, and
wherein the eNB does not send the UE information request message to the UE.

20. The method of claim 18, wherein the requesting for the UE to report the MDT measurement report comprises:
sending, by the eNB, a UE information request message to the UE,
wherein the UE sends a UE information response message to the eNB and includes the MDT measurement report into the UE information response message, and
wherein the eNB does not send the UE information request message to the UE.
